(19) United States
(12) Patent Application Publication
(10) Pub. No.: US 2020/0285166 A1
(43) Pub. Date: Sep. 10, 2020

(54) TONER FOR DEVELOPING ELECTROSTATIC IMAGE AND IMAGE FORMING METHOD

(71) Applicant: Konica Minolta, Inc., Tokyo (JP)

(72) Inventors: Masaharu MATSUBARA, Tokyo (JP); Ikuko SAKURADA, Tokyo (JP); Tomoko MINE, Tokyo (JP); Kazuhiko NAKAJIMA, Tokyo (JP)

(21) Appl. No.: 16/786,069

(22) Filed: Feb. 10, 2020

(30) Foreign Application Priority Data
Mar. 8, 2019 (JP) 2019-042749

(51) Int. Cl. G03G 9/09; G03G 9/097; G03G 9/08

(52) U.S. Cl. CPC G03G 9/0902; G03G 9/0819; G03G 9/09725

(57) ABSTRACT

A toner for developing an electrostatic image includes toner base particles containing a binder resin and an inorganic pigment, and an external additive, wherein the external additive contains alumina particles, and the number average particle size of primary particles of the alumina particles is in the range of 5 nm to 60 nm.

### CROSS-REFERENCE TO RELATED APPLICATIONS

The entire disclosure of Japanese Patent Application No. 2019-042749 filed on Mar. 8, 2019 is incorporated herein by reference in its entirety.

### BACKGROUND

### Technological Field

The present invention relates to a toner for developing an electrostatic image and an image forming method, and particularly to a toner for developing an electrostatic image and an image forming method capable of suppressing toner scattering when printing with high-coverage.

### Description of the Related Art

In recent years, in the field of a toner for developing an electrostatic image used for image formation of an electrophotographic system, development has been performed in response to various demands from the market. In particular, the kinds of recording media to be printed are increasing, and there is a very high demand from the market for the recording media compatibility of the printing machine. For example, in the case of printing on a special recording medium such as colored paper, black paper, aluminum-evaporated paper, or transparent films, it is difficult to obtain sufficient color development with only a full color toner of yellow, magenta, cyan, and black toners due to the influence of the color characteristics of the recording medium.

Therefore, in order to improve the added value of an image, studies have been made to express white, fluorescent color, metallic, or the like (see JP 2004-037565A, JP 3960318B, JP 2012-189929A, JP 2009-143092A, for example). In such a case, for example, inorganic pigments such as mica and titanium dioxide are used, and among them, titanium dioxide and zinc oxide are widely used for white toner, but there is a need to increase the content of inorganic pigments for sufficient color development.

In particular, when a transparent film is used as a medium (recording medium), by forming an image with a color toner on a white toner image, the visibility of the color toner is improved, so that the added value as an image can be increased. Further, by forming a white toner image on a colored paper, it is possible to express “white” which is difficult to express with a color toner. For this purpose, it is important to increase the hiding ratio (coating ratio) of the white toner and to further improve the whiteness, and various techniques have been developed therefor (see JP 2006-220694A, JP H1-105962A, for example).

In order to improve the hiding properties and the whiteness, particularly, titanium oxide having a high whiteness is suitably used, and it is necessary to increase the filling of the pigment and increase the adhesion amount of the white toner per unit area (see JP 2018-77348A, for example).

The role of the external additive for the toner is to improve chargeability and fluidity, and as the external additive, a fine powder of an inorganic oxide is generally used, and in many cases, silica, titania and alumina are used.

Silica fine particles are effective in improving fluidity, but because of their high negative chargeability, silica fine particles excessively increase the charge quantity of a toner, especially in a low-temperature and low-humidity environment.

Accordingly, a solution thereto is to provide the effect of suppressing the charge quantity in a low-temperature and low-humidity environment using titania fine particles having low resistance.

### SUMMARY

However, when titania is transferred to a carrier during high-coverage printing, charge transfer of the carrier is promoted due to the low resistance of titania and the charge quantity of the toner is thus reduced. Further, when the pigment is highly filled, the pigment is easily exposed on the toner surface. The external additive adhering onto the exposed pigment is more likely to be detached from the resin than the external additive adhering to the resin portion due to the difference in hardness between the pigment and the resin. Further, the detached external additive adheres to the carrier and reduces the charge quantity of the toner or makes the charge quantity of the toner non-uniform and causes toner scattering as a result.

The present invention has been made in view of the above problems and circumstances and an object thereof is to provide a toner for developing an electrostatic image and an image forming method capable of suppressing toner scattering when printing with high-coverage.

To achieve at least one of the abovementioned objects, according to an aspect of the present invention, a toner for developing an electrostatic image reflecting one aspect of the present invention comprises:

toner base particles containing a binder resin and an inorganic pigment; and

an external additive,

wherein the external additive contains alumina particles, and

a number average particle size of primary particles of the alumina particles is in the range of 5 to 60 nm.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are no intended as a definition of the limits of the present invention, wherein:

FIG. 1 is an explanatory view illustrating projected images of alumina particles according to the present invention;

FIG. 2 is an example of an electron micrograph of alumina particles according to the present invention; and

FIG. 3 is a schematic cross-sectional view illustrating an example of an electrophotographic image forming apparatus according to the present invention.

### DETAILED DESCRIPTION OF THE EMBODIMENTS

Hereinafter, embodiments of a toner for developing an electrostatic image and an image forming method according to the present invention will be described with reference to the drawings. However, the scope of the invention is not limited to the disclosed embodiments.

With the present invention as described above, it is possible to provide a toner for developing an electrostatic image and an image forming method capable of suppressing toner scattering when printing with high-coverage.

Although the mechanism of expression or action of the effects of the present invention has not been clarified, it is speculated as follows.

As the toner is highly filled with pigment, the pigment is easily exposed on the toner surface, and a large amount of inorganic pigment, which is relatively hard to the binder resin, is exposed on the toner surface. However, in the present invention, the alumina particles serving as an external additive have a small diameter in the range of 5 to 60 nm, and thus it is possible to coat the inorganic pigment exposed on the toner surface with the alumina particles and hold the alumina particles on the toner surface.

It is presumed that the alumina particles have a high Mohs hardness and even if the alumina particles are adhered to the surface of the inorganic pigment, the alumina particles are thus strongly adhered to and do not easily detach from the surface of the inorganic pigment.

Examples of an additive that can be expected to have the same effect as alumina particles generally include fine powder of inorganic oxides, which are silica, titania, and strontium titanate in many cases. However, although silica fine particles are effective in improving fluidity, silica fine particles excessively increase the charge quantity of a toner because of their high negative chargeability, especially in a low-temperature and low-humidity environment. Further, when titania fine particles are transferred to a carrier during high-coverage printing, charge transfer of the carrier is promoted due to the low resistance of titania and the charge quantity of the toner is thus reduced. Strontium titanate is a metal oxide having high hardness like alumina, but in order to exhibit triboelectric charging performance, its particle size needs to be as large as 500 to 2000 nm. However, in this case, the pigment exposed on the toner surface cannot be sufficiently coated, and the scattering of the toner cannot be suppressed.

As described above, in the present invention, it is presumed that by using alumina particles having a small diameter within the above-described specific range as an external additive of a toner containing an inorganic pigment, the inorganic pigment exposed on the surface is coated with the alumina particles when printing with high-coverage, so that toner scattering can be suppressed.

The toner for developing an electrostatic image of the present invention is a toner for developing an electrostatic image, comprising toner base particles containing a binder resin and an inorganic pigment, and an external additive, in which the external additive comprises alumina particles and the number average particle size of the primary particles of the alumina particles is in the range of 5 to 60 nm.

This feature is a technical feature common or corresponding to the following embodiments.

In an embodiment of the present invention, the amount of the inorganic pigment added is preferably in the range of 10 to 70% by mass based on the total amount of the binder resin in view of obtaining sufficient coloring power for the toner, and more preferably in the range of 20 to 40% by mass based on the total amount of the binder resin.

It is preferable that the inorganic pigment contain titanium oxide particles in view of improving the whiteness of the white toner.

It is preferable that the alumina particles have a cornered shape (a shape having a portion projecting sharply from alumina particle) from the viewpoint that the contact area between the toner base particle and the alumina particle is increased so that the alumina particles can be more strongly adhered.

It is preferable that the content of the alumina particles be in the range of 0.1 to 2.0% by mass based on the total amount of the toner base particles from the viewpoint that the inorganic pigment exposed on the surface can be reliably coated so that the toner scattering can be suppressed.

The image forming method of the present invention is an image forming method using the toner for developing an electrostatic image,

in which printing is performed at a coverage of 20% or more. This makes it possible to suppress toner scattering when printing with high-coverage.

Hereinafter, the present invention, its components, and embodiments and aspects for carrying out the present invention will be described. In addition, in the present application, “to” is used in the meaning including the numerical value described before and after it as a lower limit and an upper limit.

### [Toner for Developing Electrostatic Image]

The toner for developing an electrostatic image of the present invention is a toner for developing an electrostatic image, comprising toner base particles containing a binder resin and an inorganic pigment, and an external additive, in which the external additive comprises alumina particles and the number average particle size of the primary particles of the alumina particles is in the range of 5 to 60 nm.

The toner in the present invention refers to an aggregate of toner particles. Further, the toner particles refer to toner base particles to which an external additive is added. In the present invention, in a case where it is not necessary to distinguish between the toner base particles and the toner particles, both may be simply referred to as toner particles.

### <Toner Base Particles>

The toner base particles according to the present invention preferably contain at least a binder resin and an inorganic pigment, and further contain a release agent and the like.

### (Inorganic Pigment)

Although it is preferable that the inorganic pigment according to the present invention contain titanium oxide particles as a white pigment in view of improving the whiteness of the white toner, an inorganic pigment other than the white pigment may be included.

### <<Titanium Oxide Particles>>

The titanium oxide particles according to the present invention are preferably acicular titanium oxide having an average aspect ratio in the range of 3 to 30, more preferably an average aspect ratio in the range of 8 to 25, and still more preferably in the range of 11 to 20.

In the present invention, the average aspect ratio refers to the “average aspect ratio derived from the ratio of the number average major axis diameter to the number average minor axis diameter (the number average major axis diameter/the number average minor axis diameter)”.

Here, the “major axis diameter” of the acicular titanium oxide refers to the maximum end-to-end length, that is, the maximum major axis diameter of each individual acicular particle image in a photographic image of titanium oxide obtained by photographing at a magnification of 2000 times with a scanning electron microscope (SEM; for example, “JSM-7401F” (manufactured by JEOL Ltd.)). Meanwhile, the “minor axis diameter” refers to “diameter in a direction perpendicular to the major axis” (end-to-end length in a direction perpendicular to the major axis) at the midpoint of the major axis diameter (that is, the diameter having the maximum length).

The number average major axis diameter, number average minor axis diameter, and average aspect ratio according to the present invention may be obtained by scanning the photographic image with a scanner and selecting 30 particles at random (randomly) and binarizing the photographic image and performing calculation using an image processing analyzer “LUZEX (R) AP” (manufactured by Nireco Corporation). The average aspect ratio of 30 titanium oxide particles is calculated.

The number average major axis diameter of the acicular titanium oxide according to the present invention is preferably in the range of 1 to 7 μm in view of hiding power, and more preferably in the range of 2 to 4 μm.

The number average minor axis diameter is preferably in the range of 0.001 to 1 μm from the viewpoint of the hiding power, and more preferably in the range of 0.01 to 0.3 μm.

The acicular titanium oxide according to the present invention preferably has a sphere-equivalent particle diameter in the range of 0.1 to 1.0 in view of hiding power. This range is preferred in that the particles are prevented from becoming visually transparent therewithin without losing their scattering properties in the visible region.

In the present invention, the content of the acicular titanium oxide having an average aspect ratio in the range of 3 to 30 is preferably in the range of 5 to 100% by mass, more preferably an average aspect ratio in the range of 30 to 100% by mass, and still more preferably in the range of 55 to 100% by mass based on the total amount of titanium oxide.

The total amount of the titanium oxide refers to the content of titanium oxide contained as a white pigment, excluding titanium oxide contained as an external additive.

The value of the BET specific surface area of the acicular titanium oxide according to the present invention is preferably in the range of 3 to 50 m²/g in view of hiding power, and more preferably in the range of 8 to 30 m²/g.

In the present invention, the BET specific surface area was measured using a specific surface area measuring apparatus “GEMINI 2390” (manufactured by Shimadzu Corporation). Specifically, the measurement sample was placed in a measurement cell (25 mL) and accurately weighed with a precision balance, and after weighing was completed, vacuum suction heat treatment was performed at 200° C. for 60 minutes at a gas port attached to the apparatus. Next, the sample was set in a measurement port, and the measurement was started. The measurement was carried out by a 10-point method, and the mass of the sample was input at the end of the measurement to obtain the BET specific surface area that is automatically calculated. The measurement cell used was a cell having a spherical outer shape of 1.9 cm (0.75 inch), a length of 3.8 cm (1.5 inch), a cell length of 15.5 cm (6.1 inch), a volume of 12.0 cm³, and a sample capacity of approximately 6.00 cm³. The measurement was carried out in an environment at a temperature of 20° C. and a relative humidity of 50% without dew condensation.

Although the crystal structure of the acicular titanium oxide according to the present invention may be either of rutile type or anatase type, the rutile type having a higher refractive index is more preferable than the anatase type in view of hiding power and coloring power.

The toner of the present invention may only contain an inorganic pigment, and preferably contains the white pigment (titanium oxide) as the inorganic pigment, but may also contain an inorganic pigment other than the titanium oxide.

Specific examples of the white inorganic pigment include heavy calcium carbonate, light calcium carbonate, aluminum hydroxide, satin white, talc, calcium sulfate, barium sulfate, zinc oxide, magnesium oxide, magnesium carbonate, amorphous silica, colloidal silica, white carbon, kaolin, calcined kaolin, delaminated kaolin, aluminosilicate, sericite, bentonite, and smectite.

Further, the toner of the present invention may contain an inorganic pigment of another color except the white pigment.

Examples of the inorganic pigments of other colors except the white pigment include a magnetic material, and iron/titanium composite oxide black. As the magnetic material, for example, ferrite or magnetite may be used. These may be used singly or in combinations of two or more.

The amount of the inorganic pigment according to the present invention added is preferably in the range of 10 to 70% by mass based on the total amount of the binder resin in view of obtaining sufficient coloring power as a toner. More preferably, the amount added is in the range of 20 to 40% by mass. When the amount added is 10% by mass or more, a sufficient hiding ratio can be secured, and the initial coloring degree also does not decrease. When the amount added is 70% by mass or less, the resistance of the toner base particles decreases and the chargeability in a high-temperature and high-humidity environment (HH environment) also does not decrease. Further, by setting the inorganic pigment within the above range, the hardness of the toner base particles is increased, the alumina particles are less likely to be embedded, and the scattering of the toner during printing can thus be suppressed.

### (Binder Resin)

The toner base particles preferably contain an amorphous resin and a crystalline resin as a binder resin. Containing a crystalline resin as the binder resin allows to improve low-temperature fixability.

Here, the crystalline resin refers to a resin having a melting point, that is, a clear endothermic peak at the time of temperature rise, in an endothermic curve obtained by differential scanning calorimetry (DSC). The clear endothermic peak refers to a peak having a half-value width of 15° C. or less in the endothermic curve when the temperature is increased at a rate of 10° C./min.

Meanwhile, the amorphous resin refers to a resin in the endothermic curve obtained when the same differential scanning calorimetry is performed as above, in which a baseline curve indicating that a glass transition has occurred is seen, but no clear endothermic peak above mentioned is observed.

### (1) Amorphous Resin

Known amorphous resins may be used as the binder resin. Specific examples thereof include a vinyl resin, a urethane resin, a urea resin, and a polyester resin. Above them, vinyl resin is preferred because the variation due to environmental differences is small

The vinyl resin is not particularly limited as long as the vinyl resin is obtained by polymerizing a vinyl compound, and examples thereof include a (meth)acrylate resin, a styrene/(meth)acrylate resin, and an ethylene-vinyl acetate resin. These may be used singly or in combinations of two or more.

Among the above vinyl resins, the styrene/(meth)acrylate resin is preferred from the viewpoint of plasticity during heat fixing. Therefore, hereinafter, the styrene/(meth)acrylate resin (hereinafter, also referred to as styrene/(meth)acrylic resin) as the amorphous resin will be described.

The styrene/(meth)acrylic resin is formed by addition polymerization of at least an aromatic vinyl monomer and a (meth)acrylate monomer. The aromatic vinyl monomer includes, in addition to styrene represented by the structural formula of CH₂═CH—C₆H₅, those having a known side chain or functional group in the styrene structure. The (meth)acrylate monomer referred to herein includes, in addition to acrylate represented by CH₂CHCOOR (R represents an alkyl group) and methacrylate, those having a known side chain or functional group in the structure of the acrylate derivative, the methacrylate derivative, or the like. In the present invention, the (meth)acrylate monomer is a generic term for acrylate monomers and methacrylate monomers.

Examples of the aromatic vinyl monomer and the (meth)acrylate monomer capable of forming a styrene/(meth)acrylic resin are shown below.

Examples of the aromatic vinyl monomer include styrene, o-methylstyrene, m-methylstyrene, p-methylstyrene, α-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, and p-n-dodecylstyrene. These aromatic vinyl monomers may be used singly or in combinations of two or more.

Specific examples of the (meth)acrylate monomer include acrylate monomers such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, and phenyl acrylate; and the methacrylate monomers such as methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate, and dimethylaminoethyl methacrylate. These (meth)acrylate monomers may be used singly or in combinations of two or more.

The content of the structural unit derived from the aromatic vinyl monomer in the styrene/(meth)acrylic resin is preferably, for example, in the range of 40 to 90% by mass based on the total amount of the resin. Further, the content of the structural unit derived from the (meth)acrylate monomer in the resin is preferably, for example, in the range of 10 to 60% by mass based on the total amount of the resin.

Further, the styrene/(meth)acrylic resin may include the following monomer compounds in addition to the above aromatic vinyl monomer and the (meth)acrylate monomer. Examples of the compounds include compounds having a carboxy group such as acrylic acid, methacrylic acid, maleic acid, itaconic acid, cinnamic acid, fumaric acid, monoalkyl maleate, and monoalkyl itaconate; compounds having a hydroxy group such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate. These monomer compounds may be used singly or in combinations of two or more.

The content of structural units derived from the above monomer compounds in the styrene/(meth)acrylic resin is preferably, for example, in the range of 0.5 to 20% by mass based on the total amount of the resin.

The weight average molecular weight (Mw) of the styrene/(meth)acrylic resin is preferably, for example, in the range of 10000 to 100000.

In the present invention, the weight average molecular weight (Mw) of the resin may be determined from the molecular weight distribution measured by gel permeation chromatography (GPC).

Specifically, first, a measurement sample was added to tetrahydrofuran so as to have a concentration of 1 mg/mL, and subjected to dispersion treatment at room temperature for 5 minutes using an ultrasonic disperser, followed by treatment with a membrane filter having a pore size of 0.2 μm to prepare the sample solution. For example, using a GPC apparatus HLC-8120GPC (manufactured by Tosoh Corporation) and columns (“TSKgel guardcolumn SuperHZ-L” and “TSKgel SuperHZM-M” (manufactured by Tosoh Corporation)), while maintaining the column temperature at 40° C., tetrahydrofuran is allowed to flow at a flow rate of 0.2 mL/min as the carrier solvent. Into the GPC apparatus, 10 μL of the prepared sample solution is injected together with the carrier solvent, and the sample is detected using a refractive index detector (RI detector), and the molecular weight distribution of the sample is calculated using the calibration curve measured using monodisperse polystyrene standard particles. The calibration curve is prepared by measuring 10 points of respective polystyrene standard particles (manufactured by Pressure Chemical Co.) having the molecular weights of 6×10², 2.1×10³, 4×10³, 1.75×10⁴, 5.1×10⁴, 1.1×10⁵, 3.9×10⁵, 8.6×10⁵, 2×10⁶, and 4.48×10⁶.

The method for producing the styrene/(meth)acrylic resin is not particularly limited, and examples thereof include methods of performing known polymerization methods such as bulk polymerization, solution polymerization, emulsion polymerization, miniemulsion, dispersion polymerization, using any typical polymerization initiator used for the polymerization of the above monomers, e.g. peroxides, persulfides, persulfates, and azo compounds. For the purpose of adjusting the molecular weight, a generally used chain transfer agent may be used. The chain transfer agent is not particularly limited, and examples thereof include alkyl mercaptans such as n-octyl mercaptan, and mercapto fatty acid esters.

Although the glass transition temperature (Tg) of the amorphous resin is not particularly limited, the glass transition temperature is preferably, for example, in the range of 25 to 60° C. from the viewpoint of reliably obtaining fixability such as low-temperature fixability and heat resistance such as heat-resistant storability and blocking resistance.

Further, in order to reduce the mechanical strength of the toner and to suppress excessive embedding of the external additive, it is preferable to use a polyester resin in combination with a vinyl resin as the amorphous resin.

The polyester resin is produced by a polycondensation reaction using a polycarboxylic acid monomer (derivative) and a polyhydric alcohol monomer (derivative) as raw materials in the presence of an appropriate catalyst.

Examples of the polycarboxylic acid monomer derivatives that may be used include alkyl esters, acid anhydrides, and acid chlorides of polycarboxylic acid monomers, and examples of the polyhydric alcohol monomer derivatives that may be used include esters and hydroxycarboxylic acids of polyhydric alcohol monomers.

Examples of the polycarboxylic acid monomers include divalent carboxylic acids such as oxalic acid, succinic acid, maleic acid, adipic acid, β-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexane-3,5-diene-1,2-dicarboxylic acid, malic acid, citric acid, hexahydroterephthalic acid, malonic acid, pimelic acid, tartaric acid, mucus acid, phthalic acid, isophthalic acid, terephthalic acid, tetrachlorophthalic acid, chlorophthalic acid, nitrophthalic acid, p-carboxyphenylacetic acid, p-phenylene diacetic acid, m-phenylenediglycolic acid, p-phenylenediglycolic acid, o-phenylenediglycolic acid, diphenylacetic acid, diphenyl-p,p′-dicarboxylic acids, naphthalene-1,4-dicarboxylic acid, naphthalene-1,5-dicarboxylic acid, naphthalene-2,6-dicarboxylic acid, anthracene dicarboxylic acid, dodecenyl succinic acid; and tri- or higher valent carboxylic acids such as trimellitic acid, pyromellitic acid, naphthalenetricarboxylic acid, naphthalenetetracarboxylic acid, pyrenetricarboxylic acid, and pyrenetetracarboxylic acid. As the polycarboxylic acid monomer, it is preferable to use unsaturated aliphatic dicarboxylic acids such as fumaric acid, maleic acid, and mesaconic acid, for example. Anhydrides of dicarboxylic acid such as maleic anhydride may also be used for the present invention.

Examples of the polyhydric alcohol monomer include divalent alcohols such as ethylene glycol, propylene glycol, butanediol, diethylene glycol, hexanediol, cyclohexanediol, octanediol, decanediol, dodecanediol, ethylene oxide adducts of bisphenol A, and propylene oxide adducts of bisphenol A; and tri- or higher valent polyols such as glycerin, pentaerythritol, hexamethylolmelamine, hexaethylolmelamine, tetramethylolbenzoguanamine, and tetraethylolbenzoguanamine

### (2) Crystalline Resin

Examples of the crystalline resin include crystalline polyester resins and crystalline vinyl resins. As the crystalline resin, a crystalline polyester resin is preferable from the viewpoint of obtaining low-temperature fixability.

### (2-1) Crystalline Polyester Resin

As the crystalline polyester resin, a known polyester resin obtained by a polycondensation reaction between a di- or higher valent carboxylic acid (polycarboxylic acid) and a di- or higher valent alcohol (polyhydric alcohol) may be used.

The polycarboxylic acid refers to a compound having two or more carboxy groups in one molecule. Specific examples thereof include saturated aliphatic dicarboxylic acids such as oxalic acid, malonic acid, succinic acid, adipic acid, sebacic acid, azelaic acid, n-dodecylsuccinic acid, nonanedicarboxylic acid, decanedicarboxylic acid, undecanedicarboxylic acid, dodecanedicarboxylic acid, and tetradacandiol; alicyclic dicarboxylic acids such as cyclohexanedicarboxylic acid; aromatic dicarboxylic acids such as phthalic acid, isophthalic acid, and terephthalic acid; tri- or higher valent polycarboxylic acids such as trimellitic acid and pyromellitic acid; and anhydrides and alkyl esters having 1 to 3 carbon atoms of these carboxylic acid compounds. These may be used singly or in combinations of two or more.

The polyhydric alcohol refers to a compound having two or more hydroxy groups in one molecule. Specific examples thereof include aliphatic diols such as 1,2-propanediol, 1,3-propanediol, 1,4-butanediol, 1,5-pentanediol, 1,6-hexanediol, 1,7-heptanediol, 1,8-octanediol, 1,9-nonanediol, dodecanediol, neopentyl glycol, and 1,4-butenediol; and tri- or higher valent polyhydric alcohols such as glycerin, pentaerythritol, trimethylolpropane, and sorbitol. These may be used singly or in combinations of two or more.

In the present invention, when the number of carbon atoms of the main chain of the structural unit derived from the polyhydric alcohol for forming the crystalline polyester resin is C_{alcohol}, and the number of carbon atoms of the main chain of the structural unit derived from the polycarboxylic acid for forming the crystalline polyester resin is C_{acid}, the following Formulas (2) and (3) are preferably satisfied, from the viewpoint of forming the domain of the crystalline polyester resin in the toner base particles.

5≤|C_{acid}−C_{alcohol}|≤12 Formula (2):

C_{acid}>C_{alcohol} Formula (3):

As the difference in the alkyl chain length between the alcohol and the acid becomes larger, the crystalline polyester resin becomes harder to aggregate and the crystal can be finely dispersed. Therefore, when the difference is smaller than 5, a larger domain is formed, and when the difference is larger than 12, a smaller domain is formed.

The content of the crystalline polyester resin is, for example, preferably in the range of 5 to 20% by mass based on the total amount of the resin forming the toner particles. When the content is 5% by mass or more, sufficient low-temperature fixability can be easily obtained. When the content is 20% by mass or less, the toner can be easily produced.

### (2-2) Hybrid Crystalline Polyester Resin

The crystalline polyester resin preferably contains a hybrid crystalline polyester resin (hereinafter simply referred to as a hybrid resin) formed by chemically bonding a vinyl polymer segment as the amorphous resin segment and a polyester polymer segment as the crystalline polyester segment. The hybrid resin is preferably a crystalline resin in which a vinyl polymer segment and a polyester polymer segment are bonded via a direactive monomer. By bonding a vinyl resin to a crystalline polyester resin, the interface between the crystalline resin as the domain and the amorphous resin as the matrix in the toner base particles becomes smooth, and the dispersibility of the crystalline resin becomes good.

The vinyl polymer segment forming the hybrid resin is formed of a resin obtained by polymerizing vinyl monomers. As the vinyl monomers, the same monomers as those forming the vinyl resin described above may be used.

The content of the vinyl polymer segment in the hybrid resin is preferably, for example, in the range of 0.5 to 20% by mass.

The polyester polymer segment forming the hybrid resin is formed from a crystalline polyester resin produced by performing a polycondensation reaction between a polycarboxylic acid and a polyhydric alcohol in the presence of a catalyst. As the polycarboxylic acid and polyhydric alcohol, those described above may be similarly used.

The direactive monomer is a monomer that bonds a polyester polymer segment and a vinyl polymer segment to each other, and is a monomer having both a group selected from a hydroxy group, a carboxy group, an epoxy group, a primary amino group, and a secondary amino group forming the polyester polymer segment and an ethylenically unsaturated group forming the vinyl polymer segment in the molecule. The direactive monomer is preferably a monomer having a hydroxy group or a carboxy group and an ethylenically unsaturated group, and is preferably a monomer having a carboxy group and an ethylenically unsaturated group. Accordingly, the direactive monomer is preferably a vinyl carboxylic acid.

Examples of the direactive monomer include acrylic acid, methacrylic acid, fumaric acid, and maleic acid, and although the direactive monomer may also be esters of these hydroxyalkyls (1 to 3 carbon atoms), acrylic acid, methacrylic acid, or fumaric acid is preferred from the viewpoint of reactivity.

From the viewpoint of improving the low-temperature fixability, high-temperature offset resistance and durability of the toner, the used amount of the direactive monomer is preferably, for example, in the range of 1 to 10 parts by mass, and more preferably in the range of 4 to 8 parts by mass based on 100 parts by mass of the total amount of the vinyl monomers forming the vinyl polymer segment.

As a method for producing a hybrid resin, an existing general scheme may be used. There are the following three typical methods.

(1) A method of polymerizing a polyester polymer segment in advance, reacting a direactive monomer with the polyester polymer segment, and further reacting with an aromatic vinyl monomer and a (meth)acrylate monomer for forming a vinyl polymer segment so as to form a hybrid resin.

(2) A method of polymerizing a vinyl polymer segment in advance, reacting a direactive monomer with the vinyl polymer segment, and further reacting with a polycarboxylic acid and a polyhydric alcohol for forming a polyester polymer segment so as to form a polyester polymer segment.

(3) A method of polymerizing a polyester polymer segment and a vinyl polymer segment in advance, and reacting a direactive monomer with the polyester polymer segment and the vinyl polymer segment to bond both to each other.

In the present invention, any of the above production methods may be used, but the method (2) is preferred. Specifically, the method is preferably performed by mixing a polycarboxylic acid and a polyhydric alcohol that form a polyester polymer segment and a vinyl monomer and a direactive monomer that form a vinyl polymer segment, causing addition-polymerization between the vinyl monomer and the direactive monomer to form the vinyl polymer segment by adding a polymerization initiator, and causing polycondensation reaction by adding an esterification catalyst. As the esterification catalyst, various catalysts known in the related art may be used, examples thereof include tin compounds such as dibutyltin oxide and tin (II) 2-ethylhexanoate, and titanium compounds such as titanium diisopropylate bistriethanolaminate, and examples of esterification promotors include gallic acid.

### (Other Materials)

The toner base particles according to the present invention may optionally contain a release agent, a charge control agent, and the like.

### (Release Agent)

Examples of the release agent include polyethylene wax, paraffin wax, microcrystalline wax, Fischer-Tropsch wax, dialkyl ketone waxes such as distearyl ketone, ester waxes such as carnauba wax, montan wax, behenyl behenate, trimethylolpropane tribehenate, pentaerythritol tetramyristate, pentaerythritol tetrastearate, pentaerythritol tetrabehenate, pentaerythritol diacetate dibehenate, glycerin tribehenate, 1,18-octadecanediol distearate, tristearyl trimellitate, distearyl maleate, and amide waxes such as ethylenediamine dibehenylamide and tristearylamide trimellitate.

The content of the release agent in the toner base particles is, for example, preferably in the range of 2 to 30% by mass, and more preferably in the range of 5 to 20% by mass, based on the total mass of the toner base particles.

### (Charge Control Agent)

As the charge control agent, various known compounds dispersible in an aqueous medium may be used. Specific examples thereof include nigrosine dyes, metal salts of naphthenic acid or higher fatty acids, alkoxylated amines, quaternary ammonium salt compounds, azo metal complexes, salicylic acid metal salts, and metal complexes thereof.

The content of the charge control agent is, for example, preferably in the range of 0.1 to 10% by mass, and more preferably in the range of 0.5 to 5% by mass based on the total amount of the binder resin.

### <Particle Size of Toner Base Particles>

The volume-based median diameter of the toner base particles according to the present invention is preferably, for example, in the range of 4.5 to 8.0 μm. When the volume-based median diameter of the toner base particles is within the above range, both the image quality of the output image and the toner replenishability can be improved, and functions such as charging, development, transfer, and cleaning can also be improved. Further, the volume-based median diameter of the toner base particles is more preferably in the range of 5.0 to 6.2 whereby dot reproducibility is improved, and a higher quality image is obtained.

The volume-based median diameter of the toner base particles may be measured and calculated using, for example, an apparatus obtained by connecting “Multisizer 3 (manufactured by Beckman Coulter, Inc.)” to a computer system (manufactured by Beckman Coulter, Inc.) installed with data processing software “Software V3.51”. As the measurement procedure, a sample dispersion liquid is prepared by dispersing 0.02 g of a sample in 20 mL of a surfactant solution and allowing the mixture to conform, followed by ultrasonic dispersion for 1 minute. As the surfactant solution, for example, a solution obtained by diluting a neutral detergent containing a surfactant component 10 times with pure water may be used. The prepared sample dispersion liquid is dropped into a beaker of ISOTON II (manufactured by Beckman Coulter, Inc.) until the measured concentration becomes 5 to 10%, and then the count number of the measuring apparatus is set to 25000 to perform the measurement. Here, the aperture diameter of the Multisizer 3 is set to 100 The measurement range from 2 to 60 μm is divided into 256 sections in each of which the frequency number is calculated, and the particle size corresponding to 50% of the volume-integrated fraction from the larger particles is defined as the volume based median diameter (D₅₀).

### <Average Circularity of Toner Base Particles>

The average circularity of the toner base particles used in the present invention is preferably, for example, in the range of 0.920 to 1.000 from the viewpoint of toner replenishability. The average circularity is calculated by the following Formula (1). When the average circularity of the toner base particles is within the above range, the contact points between the toner base particles become small As a result, the responsiveness to external force is improved and the degree of fluidization is increased, so that a toner having excellent toner replenishability can be obtained. When the average circularity is within the above range, sufficient transfer efficiency can be ensured.

Average circularity=(Circumference length of circle having projected area equivalent to projected area of particle image)/(Circumference length of projected particle image) Formula (1):

An example of the measurement for obtaining the average circularity is a measurement using an average circularity measuring apparatus “FPIA-2100” (manufactured by Sysmex Corporation). As a specific operation, the sample was wetted with an aqueous solution of a surfactant, dispersed by performing ultrasonic dispersion for 1 minute, and then using “FPIA-2100” in a measurement condition of HPF (high-magnification imaging), and then measurement is performed at an appropriate concentration of 3000 to 10000 HPFs detected.

### <External Additive>

The external additive according to the present invention contains alumina particles, and the number average particle size of the alumina particles is in the range of 5 to 60 nm. Further, it is preferable that the alumina particles have a cornered shape. The external additive may contain an external additive known in the related art in addition to the alumina particles.

The amount of the external additive according to the present invention added to the toner base particles is not particularly limited, but is, for example, in the range of 0.1 to 10.0% by mass, more preferably in the range of 1.0 to 3.0% by mass based on 100% by mass of the toner.

### (Alumina Particles)

Alumina refers to aluminum oxide represented by Al₂O₃. Al₂O₃ is known to have forms such as α-type, γ-type, σ-type, and mixtures thereof, and also has a shape of a cubic to a sphere depending on the control of the crystal system.

Alumina may be produced by a known method. As a method for producing alumina, a Bayer method is generally used, but a hydrolysis method, a gas phase synthesis method, a flame hydrolysis method, an underwater spark discharge method or the like may also be used in order to obtain high-purity and nano-sized alumina

The alumina particles according to the present invention preferably have a cornered (angular) shape. When the particles have a cornered shape, the contact area between the toner base particles and the alumina particles increases, so that the alumina particles can be more strongly adhered. As a result, the transfer amount of the external additive to the carrier can be reduced, and the variation in the charge quantity due to the change of the external environment or the coverage can be suppressed. Therefore, effects such as stability of image density, suppression of fogging, improvement of dot reproducibility can be brought to the images to be formed.

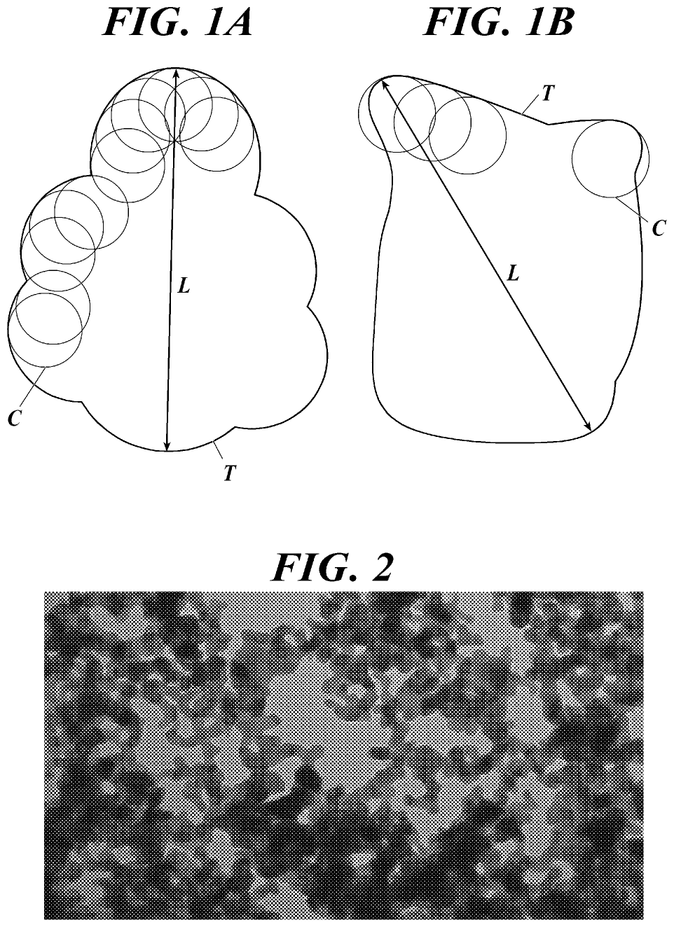

Hereinafter, the alumina particles having a cornered shape will be described with reference to FIG. 1. FIG. 1 is an explanatory view illustrating projected images of alumina particles, where FIG. 1A illustrates an alumina particle without a corner, and FIG. 1B illustrates an alumina particle with a corner.

As shown in FIG. 1, in the electron micrograph of the alumina particles with the major axis (the width of the particle corresponding to the largest distance between a pair of parallel lines each touched to different side of the projected image of the alumina particle) of L, a circle C having a radius of L/10 is rolled inside such that the circle is kept in contact with the peripheral line T of the alumina particle at one point. When the circle C does not substantially extend outside the peripheral line T of the alumina particle, the particle is referred to as being “non-cornered” (see FIG. 1A). On the other hand, when the circle C protrudes from the peripheral line T of the alumina particle, the particle is referred to as being “cornered” (see FIG. 1B).

An example of an electron micrograph of alumina particles according to the present invention is shown in FIG. 2. FIG. 2 is a TEM photograph of alumina particles photographed using the transmission electron microscope (TEM) “HF-2200” (manufactured by Hitachi High-Technologies Corporation) at an acceleration voltage of 200 kV and a magnification of 200000 times.

The number of corners of the alumina particles specified by the above method from one electron micrograph is preferably, for example, four or more per alumina particle. In such cases, the effect of the present invention can be obtained more reliably.

The shape of the alumina particles may be controlled by, for example, injecting the raw material powder into a high-temperature flame formed by a fuel gas such as hydrogen, natural gas, acetylene gas, propane gas, and butane, and causing the powder to melt and spheroidize on the basis of existing thermal spraying techniques.

The supply method when the raw material powder of the alumina particles is injected into the flame may be any of a dry method using a carrier gas such as oxygen, air, nitrogen, or argon, or a wet method using a slurry such as water, methanol, ethanol as a dispersion medium.

An example of an apparatus for producing alumina particles is an apparatus having a spheroidizing furnace and a collector connected to the spheroidizing furnace as basic components. The spherical alumina powder produced in the spheroidizing furnace is pneumatically transported by a blower or the like, and collected by a collector. It is preferable that the transport pipe for transporting the alumina powder from the spheroidizing furnace to the collector be water-cooled by a water-cooling jacket system. As the collector, for example, a cyclone, a gravity sedimentation, a louver or a bag filter is used. The collection temperature is determined by the amount of heat generated based on the amount of combustible gas and the amount of suction of the blower, and the adjustment thereof is performed based on the amount of cooling water, the intake amount of outside air provided in the line, or the like.

The shape and particle size of the alumina particles may vary depending on, for example, the flame temperature, the content of hydrogen or oxygen, the quality of the raw alumina powder, the residence time in the flame, or the length of the aggregation zone.

Further, in the alumina particles according to the present invention, the content of the cornered alumina particles is preferably, for example, 50% by number or more based on the whole alumina particles contained as an external additive in the toner.

### (Particle Size of Alumina Particles)

The number average particle size of the alumina particles is in the range of 5 to 60 nm, and preferably in the range of 5 to 40 nm. When the size is 5 nm or more, alumina particles may be produced more easily. When the size is 60 nm or less, the fluidity of the toner is improved, and when the toner is supplied to the developing unit, the toner and the carrier are sufficiently mixed, so that a more stable transition of the charge quantity can be obtained.

The number average particle size of the alumina particles may be measured as follows.

Using the scanning electron microscope (SEM) “JSM-7401F” (manufactured by JEOL Ltd.), a SEM photograph magnified 50000 times is captured by a scanner. With the image processing analyzer “LUZEX AP” (manufactured by Nireco Corporation), the alumina particles in the SEM photographic image are binarized, the Feret diameters in the horizontal direction for 100 alumina particles are calculated, and the average value thereof is defined as the number average particle size.

### (Content of Alumina Particles)

It is preferable that the content of the alumina particles be in the range of 0.1 to 2.0% by mass based on the total amount of the toner base particles from the viewpoint that the inorganic pigment exposed on the surface can be reliably coated so that toner scattering can be suppressed. When the content is 0.1% by mass or more, the effect of suppressing toner scattering is obtained. When the content is 2.0% by mass or less, it is possible to suppress the probability that the alumina particles receive the impact from the toner particles and the carrier particles when the developing agent is stirred in the developing unit during low-coverage printing to be low, so that the embedding of the alumina particles into the toner base particles is less likely to occur.

### (Hydrophobic Treatment of Alumina Particles)

The surface of the alumina particles is preferably subjected to a hydrophobic treatment with a surface treatment agent (surface modifier), and the degree of hydrophobicity is preferably, for example, in the range of 40 to 70. As a result, it is possible to more effectively suppress the variation in the charge quantity due to the environmental difference and the variation in the charge quantity when transferred to the carrier. Further, it is preferable that the liberation ratio of the surface treatment agent after the hydrophobic treatment be 0. When liberated surface treatment agent is present, the liberated surface treatment agent is transferred to the carrier, and the variation of the charge quantity is increased.

The degree of hydrophobicity of the alumina particles may be determined by measuring as follows.

In a laboratory environment, a 20 mm long stirrer chip and 60 mL of ion-exchanged water at 25° C. are placed in a 200 mL tall beaker, and set in a powder wettability tester (WET-101P; Rhesca Co., Ltd.). On ion-exchanged water, 50 mg of alumina particles are floated, and then a lid and a methanol supply nozzle are immediately set, and measurement is started at the same time as stirring with a stirrer is started. The supply rate of methanol (special grade, manufactured by Kanto Chemical Co., Inc.) is set to 2.0 mL/min, the measurement time is set to 70 minutes, and the stirring speed of the stirrer is set to 380 to 420 rpm. Although the alumina particles are initially floating at the interface of ion-exchanged water, the alumina particles are gradually wetted with a mixed solution of ion-exchanged water and methanol as the methanol concentration increases and thereby dispersed in the liquid. As a result, the light transmittance of the liquid gradually decreases. From the obtained data, the methanol concentration (vol %) calculated from the supply amount (mL) of methanol is plotted on the horizontal axis, and the light transmittance (voltage ratio) (%) is plotted on the vertical axis, and the methanol concentration at the midpoint of the maximum value and the minimum value is determined to be the degree of hydrophobicity.

Although general coupling agents, silicone oils, fatty acids, fatty acid metal salts, or the like may be used as the surface treatment agent, for example, silane compounds or silicone oils are preferably used.

Examples of the silane compounds include chlorosilane, alkoxysilane, silazane, and a special silylating agent. Specific examples thereof include methyltrichlorosilane, dimethyldichlorosilane, trimethylchlorosilane, phenyltrichlorosilane, diphenyldichlorosilane, tetramethoxysilane, methyltrimethoxysilane, dimethyldimethoxysilane, phenyltrimethoxysilane, diphenyldimethoxysilane, octyltrimethoxysilane, tetraethoxysilane, methyltriethoxysilane, dimethyldiethoxysilane, phenyltriethoxysilane, diphenyldiethoxysilane, isobutyltrimethoxysilane, decyltrimethoxysilane, hexamethyldisilazane, N,O-(bistrimethylsilyl)acetamide, N,N-bis(trimethylsilyl)urea, tert-butyldimethylchlorosilane, vinyltrichlorosilane, vinyltrimethoxysilane, vinyltriethoxysilane, γ-methacryloxypropyltrimethoxysilane, β-(3,4-epoxycyclohexyl)ethyltrimethoxysilane, γ-glycidoxypropyltrimethoxysilane, γ-glycidoxypropylmethyldiethoxysilane, γ-mercaptopropyltrimethoxysilane, and γ-chloropropyltrimethoxysilane. Particularly preferred are isobutyltrimethoxysilane and octyltrimethoxysilane.

Examples of the silicone oil include cyclic compounds such as organosiloxane oligomers, octamethylcyclotetrasiloxane, decamethylcyclopentasiloxane, tetramethylcyclotetrasiloxane, and tetravinyltetramethylcyclotetrasiloxane, and linear or branched organosiloxanes. Further, highly reactive silicone oils having at least one modified terminal, obtained by introducing a modifying group into the side chain, one terminal, or both terminals, one terminal of the side chain, both terminals of the side chain, or the like may also be used. Examples of the kinds of the modifying group include, but are not particularly limited to, alkoxy, carboxy, carbinol, modified higher fatty acids, phenol, epoxy, methacryl, and amino. Further, for example, silicone oils having several kinds of modifying groups such as an amino group and an alkoxy group may also be used. The hydrophobic treatment may be performed by using a mixture of a silicone oil and another surface treatment agent, or both the hydrophobic treatment using a silicone oil and the hydrophobic treatment using another surface treatment agent may be performed. Examples of other surface treatment agents in this case include silane coupling agents, titanate coupling agents, aluminate coupling agents, various silicone oils, fatty acids, fatty acid metal salts, esterified products thereof, and rosin acid.

Examples of methods for hydrophobizing alumina particles by a surface treatment agent include dry methods such as a spray drying method of spraying a surface treatment agent or a solution containing the surface treatment agent on alumina particles suspended in a gas phase, and a wet method of immersing alumina particles in a solution containing a surface treatment agent and drying the alumina particles, and a mixing method of mixing a surface treatment agent and alumina particles by a mixer.

### (Other External Additives)

The external additive according to the present invention preferably contains other external additives in addition to the alumina particles from the viewpoint of controlling the fluidity and chargeability of the toner particles. Examples of such external additives include silica particles, titania particles, zirconia particles, zinc oxide particles, chromium oxide particles, cerium oxide particles, antimony oxide particles, tungsten oxide particles, tin oxide particles, tellurium oxide particles, manganese oxide particles, and boron oxide particles.

The number average particle size of the other external additives may be adjusted by, for example, classification or mixing of classified products. The number average particle size of the other external additives may be measured by the same method as the method for measuring the number average particle size of the alumina particles described above.

The surface of the other external additives is preferably subjected to a hydrophobic treatment from the viewpoint of improving heat-resistant storability and environmental stability. A known surface modifier may be used for the hydrophobic treatment. Examples of the surface modifier include a silane coupling agent, a titanate coupling agent, an aluminate coupling agent, a fatty acid, a fatty acid metal salt, its esterified product, rosin acid, and silicone oil.

As other external additives, it is preferable to use silica particles from the viewpoint of imparting chargeability, and it is more preferable to use silica particles having a number average particle size of primary particles in the range of 10 to 60 nm. As a result, the fluidity of the toner is improved, and when the toner is supplied to the developing unit, the toner particles and the carrier particles can be sufficiently mixed, so that a stable variation in the charge quantity can be obtained. Further, it is preferable to use silica particles having a number average particle size of the primary particles in the range of 80 to 150 nm in combination with the silica particles having a number average particle size of primary particles in the range of 10 to 60 nm. As a result, the impact between the toner particles and the carrier particles when the developing agent is stirred in the developing unit during low-coverage printing can be reduced.

Organic particles may also be used as the other external additives. As the organic particles, spherical organic particles having a number average particle size of approximately 10 to 2000 nm may be used. Specifically, organic particles formed of a homopolymer of styrene or methyl methacrylate or a copolymer thereof may be used. In addition, a lubricant may also be used as the other external additive. The lubricant is used for the purpose of further improving the cleanability and the transferability, and specific examples thereof include metal salts of higher fatty acids such as stearate salt of zinc, aluminum, copper, magnesium, calcium, or the like, oleate salt of zinc, manganese, iron, copper, magnesium, or the like, palmitate salt of zinc, copper, magnesium, calcium, or the like, linoleate salt of zinc, calcium, or the like, and ricinoleate salt of zinc, calcium, or the like.

### [Method for Producing Toner for Developing Electrostatic Image]

The toner base particles according to the present invention contain a binder resin and an inorganic pigment, and optionally contain other internal additives such as a release agent and a charge control agent. The production method is not particularly limited, but an emulsion aggregation method is preferred. According to the emulsion aggregation method, toner particles having a sharp particle size distribution and a highly controlled particle size can be obtained.

An example of each of the steps of the method for producing a toner by the emulsion aggregation method of the present invention will be described below.

(1) Preparing a dispersion liquid in which inorganic pigment particles are dispersed in an aqueous medium;

(2) Preparing a dispersion liquid in which binder resin particles optionally containing an internal additive are dispersed in an aqueous medium;

(3) Mixing the dispersion liquid of the inorganic pigment particles and the dispersion liquid of the binder resin particles to form toner base particles by aggregating, associating, and fusing the inorganic pigment particles and the binder resin particles;

(4) Filtering the toner base particles from the dispersion (aqueous medium) of the toner base particles to remove surfactant and the like;

(5) Drying the toner base particles; and

(6) Adding an external additive to the toner base particles.

In the step (3), it is preferable to add an aggregating agent in order to aggregate the binder resin particles and the like.

The aggregating agent used in the present invention is not particularly limited, but an aggregating agent selected from metal salts is preferably used. For example, salts of monovalent metals such as salts of alkali metals such as sodium, potassium, and lithium, salts of divalent metals such as calcium, magnesium, manganese, and copper, and salts of trivalent metals such as iron and aluminum. Specific examples of the salts include sodium chloride, potassium chloride, lithium chloride, calcium chloride, magnesium chloride, zinc chloride, copper sulfate, magnesium sulfate, and manganese sulfate, and of these, divalent metal salts are particularly preferred. When the divalent metal salts are used, aggregation can be promoted with a smaller amount. These may be used singly or in combinations of two or more.

Further, the toner base particles according to the present invention preferably have a core-shell structure, and the above-described method for producing a toner by the emulsion aggregation method is suitable for producing the toner base particles having a core-shell structure. That is, first, the binder resin particles for the core particles and the colorant particles are aggregated, associated, and fused to prepare the core particles. Subsequently, the binder resin particles for a shell layer are added to the dispersion liquid of the core particles, and the binder resin particles for the shell layer are aggregated and fused on the surface of the core particles to form the shell layer coating the surface of the core particles. As a result, toner base particles having a core-shell structure can be obtained.

### [Two-Component Developing Agent for Developing Electrostatic Images]

The two-component developing agent for developing an electrostatic image (hereinafter, also referred to as a two-component developing agent) may be prepared by, for example, appropriately mixing the toner and the carrier particles so that the content of the toner (toner concentration) becomes 4.0 to 8.0% by mass. Examples of the mixing device used for the mixing include a Nauta mixer, a W cone, and a V-type mixer.

### <Carrier Particles>

The carrier particles according to the present invention are formed of a magnetic material. Examples of the carrier particles include coated carrier particles each having a core particle made of a magnetic material and a coating material layer coating the surface of each core particle, and resin-dispersed carrier particles obtained by dispersing a fine powder of magnetic material in resin. The carrier particles are preferably coated carrier particles from the viewpoint of suppressing adhesion of the carrier particles to the photoreceptor.

(Carrier Core (Core Particle))

The core particle included in the coated carrier particle is formed of a magnetic material, for example, a substance that is strongly magnetized by a magnetic field in a direction thereof. Examples of the magnetic material include metals exhibiting ferromagnetism, such as iron, nickel, and cobalt, alloys or compounds containing these metals, and alloys exhibiting ferromagnetism by heat treatment. These magnetic materials may be used singly or in combinations of two or more.

Examples of the metals exhibiting ferromagnetism or compounds containing the same include iron, ferrites represented by the following Formula (a), and magnetites represented by the following Formula (b).

MO.Fe₂O₃ Formula (a):

MFe₂O₄ Formula (b):

(In Formulas (a) and (b), each M represents one or more monovalent or divalent metals selected from the group of Mn, Fe, Ni, Co, Cu, Mg, Zn, Cd, and Li.)

Examples of the alloys exhibiting ferromagnetism by above heat treatment include Heusler alloys such as manganese-copper-aluminum and manganese-copper-tin, and chromium dioxide.

The magnetic materials contained in the core particles are preferably, for example, various ferrites. This is because the specific gravity of the coated carrier particles becomes smaller than the specific gravity of the metal forming the core particles, so that the impact force of stirring in the developing unit can be further reduced.

(Carrier Coat Resin (Coating Material))

As the coating material included in the coated carrier particle, a known resin used for coating core particles of carrier particles may be used. The coating material preferably contains a resin having a cycloalkyl group from the viewpoint of reducing the moisture adsorption of the carrier particles and increasing the adhesion to the core particles.

Examples of the cycloalkyl group include a cyclohexyl group, a cyclopentyl group, a cyclopropyl group, a cyclobutyl group, a cycloheptyl group, a cyclooctyl group, a cyclononyl group, and a cyclodecyl group. Among them, a cyclohexyl group or a cyclopentyl group is preferable, and a cyclohexyl group is more preferable from the viewpoint of adhesion to carrier particles containing ferrite.

The weight average molecular weight Mw of the resin forming the coating material is preferably, for example, in the range of 10000 to 800000, and more preferably in the range of 100000 to 750000. The content of the cycloalkyl group in the resin is preferably, for example, in the range of 10 to 90% by mass. The content of the cycloalkyl group in the resin may be determined by, for example, pyrolysis-gas chromatograph/mass spectrometer (Py-GC/MS) or ¹H-NMR.

### [Image Forming Method]

The toner for developing an electrostatic image of the present invention can be suitably used in an image forming method by a general electrophotographic system.

The image forming method of the present invention is an electrophotographic image forming method using the toner for developing an electrostatic image, in which printing is performed at a coverage of 20% or more.

The coverage indicates information on the amount of the toner used per predetermined area as shown in the following equation.

Coverage=(total of the density values of each pixel)/(total when the entire surface has a density value of 100%)

The coverage of 20% refers to an output image adjusted such that the total of the density values of the white toner is 20%.

The image forming method of the present invention preferably has at least a charging step, a latent image forming step, a developing step, a transferring step, a fixing step, and a cleaning step.

### <Charging Step>

In this step, the electrophotographic photosensitive member is charged. The method of charging is not particularly limited, and, for example, a charger described below may be suitably used.

### <Latent Image Forming Step>

In this step, an electrostatic latent image is formed on the electrophotographic photoreceptor (electrostatic latent image carrier).

The electrophotographic photoreceptor is not particularly limited, and examples thereof include a drum-shaped photoreceptor formed of an organic photoreceptor such as polysilane or phthalopolymethine.

The formation of the electrostatic latent image is performed by uniformly charging the surface of the electrophotographic photoreceptor by a charger and by imagewisely exposing the surface of the electrophotographic photoreceptor by an exposer, as described later.

The exposer is not particularly limited, and those described later may be used.

### <Developing Step>

The developing step is a step of developing the electrostatic latent image with a dry developing agent containing a toner to form a toner image.

The formation of the toner image is performed using a dry developing agent containing a toner, for example, using a developer described below.

Specifically, in the developer, for example, the toner and the carrier are mixed and stirred, the toner is charged by friction at that time, and is held on the surface of the rotating magnet roller to form a magnetic brush. Since the magnet roller is disposed near the electrophotographic photoreceptor, a part of the toner forming the magnetic brush disposed on the surface of the magnet roller moves to the surface of the electrophotographic photoreceptor by electric attraction. As a result, the electrostatic latent image is developed by the toner, and the toner image is formed on the surface of the electrophotographic photoreceptor.

### <Transferring Step>

In this step, the toner image is transferred to a transfer material.

The transfer of the toner image to the transfer material is performed by separation charging of the toner image on the transfer material.

As a transferer, for example, a corona transfer device using corona discharge, a transfer belt or a transfer roller may be used.

The transferring step may be performed by, for example, a mode in which by using an intermediate transfer member (intermediate transfer member), a toner image is primarily transferred onto the intermediate transfer member, and then the toner image is secondarily transferred onto a transfer material, or another mode in which a toner image formed on the electrophotographic photoreceptor is directly transferred to a transfer material.

The transfer material is not particularly limited, and examples thereof include various transfer materials such as plain paper from thin paper to thick paper, high-quality paper, coated printing paper such as art paper or coated paper, commercially available Japanese paper and postcard paper, OHP plastic film, and cloth.

### <Fixing Step>

In the fixing step, the toner image transferred to the transfer material is fixed to the transfer material. The fixing method is not particularly limited, and a known fixer as described later may be used. Specific examples of the fixer include a heating roller fixing type fixer formed by a heating roller having a heat source therein and a pressure roller provided in pressure contact with the heating roller so as to form a fixing nip.

### <Cleaning Step>

In this step, the liquid developing agent not used for image formation or remaining without being transferred on the developing agent carrier such as a developing roller, a photoreceptor, and an intermediate transfer member is removed from the developing agent carrier.

The cleaning method is not particularly limited, but is preferably a method of rubbing the surface of the photoreceptor using a blade provided at the tip in contact with the photoreceptor, and for example, a cleaner as described later may be used.

Further, in the cleaning step, it is preferable to transfer a white toner for developing an electrostatic image to a non-image forming area of the intermediate transfer member corresponding to a region between the transfer materials that are continuously conveyed, to collect the white toner for developing an electrostatic image using a cleaner such as a blade, and to clean the intermediate transfer member using the white toner for developing an electrostatic image.

### [Image Forming Apparatus]

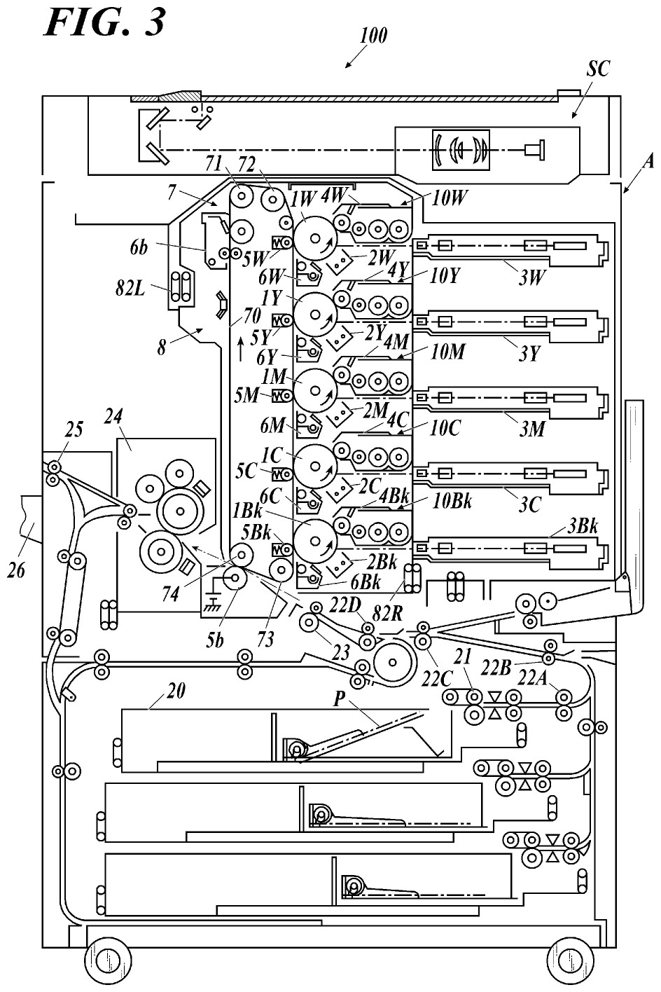

FIG. 3 illustrates, as an example, an image forming apparatus that may use the toner for developing an electrostatic image of the present invention.

In a preferred mode, the image forming apparatus has a charger, an electrostatic image former, a developer, a transferer, a fixer, and a cleaner, and the developer develops the electrostatic image with a developing agent for developing an electrostatic image containing the toner for developing an electrostatic image of the present invention to form a toner image.

Further, it is preferable for the image forming apparatus to have five or more electrostatic image formers and five or more developers, for example, electrostatic image formers and developers respectively corresponding to five colors of white (W), yellow (Y), magenta (M), cyan (C), and black (Bk) because a full-color image realizing white having hiding properties, hue, and transferability that can meet the demands of the production print market can be formed.

The image forming apparatus 100 is referred to as a tandem type color image forming apparatus, and includes five sets of image formers (image forming unit) 10W, 10Y, 10M, 10C, and 10Bk, an endless belt-shaped intermediate transfer member 7, a sheet feeder 21, and a fixer 24. A document image reading device SC is disposed above the main body A of the image forming apparatus 100.

The image former 10W forming a white image has a drum-shaped photoreceptor 1W, a charger 2W, an exposer 3W, a developer 4W, a primary transfer roller 5W as a primary transferer, and a cleaner 6W.

The image former 10Y forming a yellow image has a drum-shaped photoreceptor 1Y, a charger 2Y disposed around the drum-shaped photoreceptor 1Y, an exposer 3Y, a developer 4Y, a primary transfer roller 5Y as a primary transferer, and a cleaner 6Y.

The image former 10M forming a magenta image has a drum-shaped photoreceptor 1M, a charger 2M, an exposer 3M, a developer 4M, a primary transfer roller 5M as a primary transferer, and a cleaner 6M.

The image former 10C forming a cyan image has a drum-shaped photoreceptor 1C, a charger 2C, an exposer 3C, a developer 4C, a primary transfer roller 5C as a primary transferer, and a cleaner 6C.

The image former 10Bk forming a black image has a drum-shaped photoreceptor 1Bk, a charger 2Bk, an exposer 3Bk, a developer 4Bk, a primary transfer roller 5Bk as a primary transferer, and a cleaner 6Bk.

The five sets of image formers (10W, 10Y, 10M, 10C, and 10Bk) respectively include the photoreceptors 1W, 1Y, 1M, 1C, and 1Bk at the center, the chargers 2W, 2Y, 2M, 2C, and 2Bk, the exposers 3W, 3Y, 3M, 3C, and 3Bk as electrostatic image formers, the rotating developers 4W, 4Y, 4M, 4C, and 4Bk, and the cleaners 6W, 6Y, 6M, 6C, and 6Bk that clean the photoreceptors 1W, 1Y, 1M, 1C, and 1Bk.

The image formers 10W, 10Y, 10M, 10C, and 10Bk have the same configuration except that the colors for the toner image formed on the photoreceptors 1W, 1Y, 1M, 1C, and 1Bk are different, and the image former 10W will be described below in detail as an example.

In the image former 10W, the charger 2W, the exposer 3W, the developer 4W, and the cleaner 6W are disposed around the photoreceptor 1W which is the image forming member to form the white (W) toner image on the photoreceptor 1W. In the present embodiment, at least the photoreceptor 1W, the charger 2W, the developer 4W, and the cleaner 6W of the image former 10W are integrally provided.

The charger 2W is a means that applies a constant potential to the photoreceptor 1W. In the present invention, examples of the charger include contact or non-contact roller charging type chargers.

The exposer 3W is an electrostatic image former that performs exposure based on an image signal (white) on the photoreceptor 1W to which a constant potential is applied by the charger 2W to form an electrostatic latent image that corresponds to a white image, and the exposer 3W to be used may include an LED in which light emitting elements are arranged in an array in the axial direction of the photoreceptor 1W and an image forming element, or may be a laser optical system, or the like.

The developer 4W includes, for example, a developing sleeve that incorporates a magnet and rotates while holding the developing agent, and a voltage applying device that applies a DC and/or AC bias voltage between the developing sleeve and the photoreceptor. In particular, it is preferable that the developer 4W develop the electrostatic image with the developing agent for developing an electrostatic image containing the white toner for developing an electrostatic image of the present invention to form the toner image.

The fixer 24 may be a heating roller fixing type fixer including a heating roller having a heat source therein and a pressure roller provided in pressure contact with the heating roller so as to form a fixing nip.

The cleaner 6W includes a cleaning blade and a brush roller provided upstream of the cleaning blade.

The aforementioned components, including the photoreceptor, the developer, and the cleaner, may be integrated into a processing cartridge (image former) that may be detachably provided on the main body of the image forming apparatus 100. Alternatively, the photoreceptor and at least one of the charger, exposer, developer, transferer or cleaner may be integrally supported to form a single processing cartridge (image former) that is detachably provided on the apparatus main body with a guide, such as a rail in the apparatus main body.

The endless belt-shaped intermediate transfer member unit 7 has an endless belt-shaped intermediate transfer member 70 as a semiconductive endless belt-shaped second image carrier rotatably supported by a plurality of rollers.

The images of the respective colors formed by the image formers 10W, 10Y, 10M, 10C, and 10Bk are sequentially transferred by primary transfer rollers 5W, 5Y, 5M, 5C, and 5Bk as the primary transferers onto the endless belt-shaped intermediate transfer member 70 to form a combined color image. A transfer material (an image support that carries a fixed final image: plain paper, a transparent sheet, or the like) P accommodated in the sheet cassette 20 is supplied by a sheet feeder 21 and is conveyed via a plurality of intermediate rollers 22A, 22B, 22C, and 22D and the registration roller 23 to a secondary transfer roller 5b as a secondary transferer, and the toner image is secondarily transferred onto the transfer material P, whereby the color image is collectively transferred. The transfer material P to which the color image has been transferred is subjected to a fixing treatment by the fixer 24, and is sandwiched by sheet discharge rollers 25 and placed on a sheet discharge tray 26 outside the apparatus. Here, transfer supports for the toner image formed on the photoreceptor such as the intermediate transfer member and the transfer material is generically referred to as transfer medium.

After the transfer of the color image onto the transfer material P with the secondary transfer roller 5b as the secondary transferer and the curvature separation of the transfer material P from the endless belt-shaped intermediate transfer member 70, the residual toner on the transfer member is removed by the cleaner 6b.

During the image forming treatment, the primary transfer roller 5Bk is always in contact with the photoreceptor 1Bk. The other primary transfer rollers 5W, 5Y, 5M, and 5C contact the corresponding photoreceptors 1W, 1Y, 1M, and 1C only during color image formation.

Further, the primary transfer roller 5W may also be brought into contact with the photoreceptor 1W to develop and transfer the toner for developing an electrostatic image of the present invention to the intermediate transfer member 70 even when the image is not formed.

Usually, since an image is not formed on the region between transfer materials P, which are continuously conveyed, the toner image of each color thus is not transferred to the non-image forming area of the intermediate transfer member 70 corresponding to the region between the transfer materials P, but in this configuration, the toner for developing an electrostatic image of the present invention is developed and transferred to the non-image forming area of the intermediate transfer member 70. Since the toner is not transferred to the transfer material P, the toner is held by the intermediate transfer member 70 without being transferred by the secondary transfer roller 5b, and then removed by the cleaner 6b.

The secondary transfer roller 5b contacts the endless belt-shaped intermediate transfer member 70 only when the transfer material P passes therethrough and the secondary transfer is performed.

A housing 8 can be withdrawn along supporting rails 82L and 82R from the apparatus main body A.

The housing 8 includes the image formers 10W, 10Y, 10M, 10C, and 10Bk, and the endless belt-shaped intermediate transfer member unit 7.

The image formers 10W, 10Y, 10M, 10C, and 10Bk are arranged in tandem in the vertical direction. The endless belt-shaped intermediate transfer member unit 7 is disposed on the left side of the photoreceptors 1W, 1Y, 1M, 1C, and 1Bk in the figure. The endless belt-shaped intermediate transfer member unit 7 includes the endless belt-shaped intermediate transfer member 70 that is rotatable around rollers 71, 72, 73, and 74, primary transfer rollers 5W, 5Y, 5M, 5C, and 5Bk, and the cleaner 6b.

Although a color laser printer is shown in the image forming apparatus 100 shown in FIG. 3, the present invention may be similarly applied to a monochrome laser printer and copy machine. Further, a light source other than a laser, for example, an LED light source may be used as the exposure light source.

Further, it is preferable for the image forming apparatus 100 to have five or more electrostatic image formers and five or more developers because a full-color image realizing white excellent in hiding properties, hue, and transferability that can meet the demands of the production print market can be formed.

The embodiments to which the present invention can be applied are not limited to the above-described embodiments, and can be appropriately changed without departing from the gist of the present invention.

### EXAMPLES

Hereinafter, the present invention will be described specifically with reference to Examples, but the present invention is not limited thereto.

### [Production of Alumina Particles A1]

In an evaporator, aluminum trichloride (AlCl₃) is evaporated at about 200° C. at a rate of 320 kg/h, and the vapor of aluminum trichloride was supplied by nitrogen into the combustion chamber of a known burner device (see EP 0585544B). Here, aluminum trichloride vapor was mixed with hydrogen 100 Nm³/h and air 450 Nm³/h, and fed into the flame in the combustion chamber through the inner tube (diameter 7 mm) of the double jacketed tube projecting from the combustion chamber. The temperature in the combustion chamber (hereinafter also referred to as a burner temperature) was 230° C., and the discharge rate of aluminum trichloride vapor from the inner tube to the combustion chamber was 38 m/s. Further, 0.05 Nm³/h of hydrogen was supplied into the combustion chamber via the outer tube of the double jacketed tube. Aluminum trichloride vapor was burned in the combustion chamber and cooled to about 110° C. in an aggregation zone downstream of the combustion chamber to obtain primary particles of aluminum oxide. The primary particles of aluminum oxide thus obtained were separated from the hydrochloric acid-containing gas that was simultaneously generated in a filter or a cyclone, and the powder containing moist air was treated at about 500 to 700° C. to remove adhesive chlorides, whereby alumina particles were obtained.

The alumina particles thus obtained were placed in a reaction vessel, and a solution obtained by diluting 20 g of isobutyltrimethoxysilane as a hydrophobizing agent with 60 g of hexane was added to 100 g of alumina particles while stirring with a rotary blade under a nitrogen atmosphere. The mixture solution was heated and stirred at 200° C. for 120 minutes, and then cooled with cooling water to obtain alumina particles A1.

The number average particle size of the alumina particles A1 thus obtained was 20 nm. The alumina particles A1 contained 93% by number of cornered alumina particles, and the average value of the number of corners per alumina particle was 4.1.

### <<Preparation of Alumina Particles A2 to A5>>

Alumina particles A2 to A5 were prepared in the same manner except that the burner temperature and the discharge rate of aluminum trichloride vapor were changed from those in the preparation of the alumina particles A1, as shown in Table I.

TABLE I

| | | | | | | Number of |
|---|---|---|---|---|---|---|
| | | | Number | | | corners per |
| Alumina | Burner | Discharge | average | Presence or | Ratio of cornered | particle (average |
| particles | temperature | rate | particle size | absence of | alumina particles | value) |
| No. | [° C.] | [m/s] | [nm] | corner | [number %] | [number] |
| A1 | 230 | 38 | 20 | Cornered | 93 | 4.1 |
| A2 | 230 | 45 | 10 | Cornered | 80 | 3.6 |
| A3 | 230 | 30 | 60 | Cornered | 88 | 4.7 |
| A4 | 300 | 38 | 20 | Non-cornered | 0 | 0 |
| A5 | 230 | 25 | 70 | Cornered | 84 | 4.5 |

### [Production of Toner Base Particles 1]

### <Synthesis of Amorphous Resin [1]>

90 parts by mass of terephthalic acid (TPA), 6 parts by mass of trimellitic acid (TMA), 19 parts by mass of fumaric acid (FA), 85 parts by mass of dodecenylsuccinic anhydride (DDSA), 351 parts by mass of bisphenol A propylene oxide adduct (BPA-PO), and 58 parts by mass of bisphenol A ethylene oxide adduct (BPA-EO) were placed in a reaction vessel equipped with a stirrer, thermometer, cooling pipe, and nitrogen gas introduction pipe, and the inside of the reaction vessel was purged with dry nitrogen gas, and thereafter, 0.1 parts by mass of titanium tetrabutoxide was added, and a polymerization reaction was carried out for 8 hours while stirring at 180° C. under a nitrogen gas stream. Furthermore, 0.2 parts by mass of titanium tetrabutoxide was added, the temperature was raised to 220° C., and a polymerization reaction was carried out for 6 hours with stirring, and then the pressure in the reaction vessel was reduced to 10 mmHg, and the reaction was performed under reduced pressure, whereby a pale yellow transparent amorphous resin [1] (amorphous polyester resin) was obtained. The amorphous resin [1] had a glass transition point (Tg) of 59° C., a softening point of 101° C., and a weight average molecular weight (Mw) of 17000.

### <Synthesis of Crystalline Polyester Resin [1]>

330 parts by mass of 1,10-dodecanedioic acid and 230 parts by mass of 1,9-nonanediol were placed in a reaction vessel equipped with a stirrer, thermometer, cooling pipe, and nitrogen gas introduction pipe, and the inside of the reaction vessel was replaced with dry nitrogen gas, and thereafter, 0.1 parts by mass of titanium tetrabutoxide was added, and a polymerization reaction was carried out for 8 hours while stirring at 180° C. under a nitrogen gas stream. Furthermore, 0.2 parts by mass of titanium tetrabutoxide was added, the temperature was raised to 220° C., and a polymerization reaction was carried out for 6 hours with stirring, and then the pressure in the reaction vessel was reduced to 10 mmHg, and the reaction was performed under reduced pressure, whereby a crystalline polyester resin [1] was obtained. The crystalline polyester resin [1] had a melting point (Tm) of 72° C. and a weight average molecular weight (Mw) of 15000.

### <Particle Size Control Step>

285 parts by mass of amorphous resin [1], 58 parts by mass of crystalline polyester resin [1], 103.5 parts by mass of titanium oxide 1 (acicular titanium oxide “FT-1000” (Ishihara Sangyo Kaisha, Ltd.)), and 70 parts by mass of release agent: Fischer-Tropsch wax “FNP-0090” were kneaded at 120° C. using a twin-screw extruder. After kneading, the mixture was cooled to 25° C.

Next, after coarsely pulverizing with a hammer mill, coarse powder was coarsely pulverized with a turbo mill pulverizer (manufactured by Turbo Kogyo Co., Ltd.), and further subjected to fine powder classification with an airflow classifier utilizing the Coanda effect, whereby white base particles having a volume median diameter of 7.20 μm and a coefficient of variation (CV) of the particle size distribution of 30% were produced.

### <Circularity Control Step>

After adding the base particles to an aqueous dispersion medium in which 5 parts by mass of polyoxyethylene lauryl ether sodium sulfate was dissolved in 500 parts by mass of ion-exchanged water, the mixture was kept at 80° C. for 3.5 hours, and the cooling step was started at the time point when the circularity reached 0.932. After repeating filtration and washing, drying was performed to obtain toner base particles 1.

### [Production of Toner Base Particles 2 to 7]

In the production of the toner base particles 1, toner base particles 2 to 7 were obtained in the same manner except that the pigment type and the amount of the pigment added based on the binder resin were changed as shown in Table II below.

In the table, “PY74” represents Pigment Yellow 74 (organic pigment).

TABLE 2
Table II

Inorganic pigment

| Toner base | | Amount added based |
|---|---|---|
| particles | | on binder resin |
| No. | Pigment type | [mass %] |
| 1 | TiO₂ | 30 |
| 2 | TiO₂ | 70 |
| 3 | TiO₂ | 10 |
| 4 | TiO₂ | 20 |
| 5 | TiO₂ | 40 |
| 6 | ZnO | 40 |
| 7 | PY74 | 10 |

### [Production of Toner 1]

### <External Additive Treatment Step>

Into the toner base particles 1 produced as described above,

silica particles S1 (HMDS treatment, degree of hydrophobicity: 72, number average primary particle size=110 nm): 0.3% by mass,
silica particles S2 (HMDS treatment, degree of hydrophobicity: 67, number average primary particle size=12 nm): 0.8% by mass, and

alumina particles A1: 0.5% by mass

were added to a Henschel mixer type “FM20C/I” (manufactured by Nippon Coke & Engineering Co., Ltd.), and stirring was performed for 25 minutes at a rotation speed such that the circumferential speed of the blade tip becomes 50 m/s so as to produce “toner 1” including toner base particles 1.

The product temperature at the time of mixing the external additive was set to be 40° C.±1° C., and the internal temperature of the Henschel mixer was controlled by allowing cooling water to flow through the outer bath of the Henschel mixer at a flow rate of 5 L/min in a case in which the temperature reached 41° C. and allowing cooling water to flow at a flow rate of 1 L/min in a case in which the temperature reached 39° C.

### [Production of Toners 2 to 17]

In the production of the toner particles 1, the toners 2 to 17 were prepared in the same manner except that the toner base particles used, the type of external additives, and the shape of alumina (external additives formulations A to K) were changed as shown in Table III below.

### [Production of Developing Agent]

The toners 1 to 17 thus produced were mixed with a ferrite carrier which had a volume average particle size of 30 μm and was coated with a copolymer resin of cyclohexyl methacrylate with methyl methacrylate (monomer mass ratio=1:1) so as to have a toner concentration of 6% by mass, thereby producing developing agents 1 to 17, and the developing agents were subjected to the following evaluations. The mixing was performed for 30 minutes using a V-type mixer.

### [Evaluation]

### <Whiteness>

Using an image forming apparatus “BIZHUB PRESS C1070” (manufactured by Konica Minolta, Inc.), the obtained two-component developing agents 1 to 17 were sequentially loaded into a cyan developing unit, and were evaluated at normal temperature and normal humidity (temperature 20° C., relative humidity 50% RH).

400000 sheets of character images having the coverages shown in Table III below were printed on A4 high-quality paper (64 g/m²). After completion of 5000 prints and completion of 400000 prints, solid white images were printed on the high quality paper.

The output image was placed on 10 sheets of white paper (mondi 90) superimposed one on another so that the image surface faced up and subjected to colorimetry by a densitometer FD-7 (manufactured by Konica Minolta, Inc.) to examine the CIE 1976 (L*a*b*) color space. Based on the L* value of the CIE 1976 (L*a*b*) color space thus obtained, the degree of whiteness was evaluated according to the following criteria. The evaluation criteria are as follows, and AA and BB were considered to be acceptable.

AA: L* value is 93 or more.

BB: L* value is 85 or more and less than 93.

CC: L* value is less than 85.

DD: White is not exhibited.

### <Toner Scattering>

The evaluation of toner scattering was made as follows by visually observing the stain state inside the apparatus due to toner scattering and carrier scattering around the developing unit after completion of printing of 200000 sheets.

The evaluation of toner scattering was evaluated according to the following evaluation criteria, and in the present invention, AA, BB, and CC were considered to be acceptable. The evaluation results are shown in Table III.

AA: No toner scattering is observed. When the user replaces the developing unit, the hands are not stained at all.

BB: No toner scattering is observed. When the user replaces the developing unit, the hands become slightly dirty.

CC: Adhesion of scattered toner to the upper cover near the developing roller is observed.

DD: Adhesion of scattered toner to a part of the upper cover near the developing unit is observed.

EE: Toner scattering enough to require hand washing after the user replaces the developing unit is observed.

FF: Adhesion of fully scattered toner onto the developing unit is seen and toner scattering enough to require hand washing is observed.

TABLE III

| | | | | | | External additive | | | | | | | | | | | | |
|---|---|---|---|---|---|---|---|---|---|---|---|---|---|---|---|---|---|---|
| | | | | | | | Silica | Silica | | | | | | | | | | |
| | | | | | | | particles | particles | Titania | Strontium | | | | | | | | |
| | De- | | Toner | | | | S1 | S2 | particles | titanate | Alumina particles | | | | | | | |
| | velop- | | base | Pigment | | External | (110 nm) | (12 nm) | (25 nm) | (800 nm) | | Number | | | | | | |
| | ing | | par- | Pig- | Amount | additive | Amount | Amount | Amount | Amount | | average | | Amount | | | | |
| | agent | Toner | ticles | ment | added | for- | added | added | added | added | | particle size | | added | Coverage | Whiteness | | Toner |
| | No. | No. | No. | type | [mass %] | mulation | [mass %] | [mass %] | [mass %] | [mass %] | No. | [nm] | Corner | [mass %] | [%] | Value | Evaluation | scattering |
| Example 1 | 1 | 1 | 1 | TiO₂ | 30 | A | 0.3 | 0.8 | — | — | A1 | 20 | Cornered | 0.5 | 20 | 94.1 | AA | AA |
| Example 2 | 2 | 2 | 2 | TiO₂ | 70 | A | 0.3 | 0.8 | — | — | A1 | 20 | Cornered | 0.5 | 20 | 95 | AA | CC |
| Example 3 | 3 | 3 | 3 | TiO₂ | 10 | A | 0.3 | 0.8 | — | — | A1 | 20 | Cornered | 0.5 | 20 | 93.1 | AA | CC |
| Example 4 | 4 | 4 | 4 | TiO₂ | 20 | A | 0.3 | 0.8 | — | — | A1 | 20 | Cornered | 0.5 | 20 | 93.5 | AA | BB |
| Example 5 | 5 | 5 | 5 | TiO₂ | 40 | A | 0.3 | 0.8 | — | — | A1 | 20 | Cornered | 0.5 | 20 | 94.5 | BB | DD |
| Example 6 | 6 | 6 | 6 | ZnO | 40 | A | 0.3 | 0.8 | — | — | A1 | 20 | Cornered | 0.5 | 20 | 87 | BB | CC |
| Example 7 | 7 | 7 | 1 | TiO₂ | 30 | B | 0.3 | 0.8 | — | — | A2 | 10 | Cornered | 0.5 | 20 | 93.5 | AA | BB |
| Example 8 | 8 | 8 | 1 | TiO₂ | 30 | C | 0.3 | 0.8 | — | — | A3 | 60 | Cornered | 0.5 | 20 | 93.7 | AA | CC |
| Example 9 | 9 | 9 | 1 | TiO₂ | 30 | D | 0.3 | 0.8 | — | — | A4 | 10 | Non- | 0.5 | 20 | 93.6 | AA | CC |
| | | | | | | | | | | | | | cornered | | | | | |
| Example 10 | 10 | 10 | 1 | TiO₂ | 30 | E | 0.3 | 0.8 | — | — | A1 | 20 | Cornered | 0.1 | 20 | 93.5 | AA | CC |
| Example 11 | 11 | 11 | 1 | TiO₂ | 30 | F | 0.3 | 0.8 | — | — | A1 | 20 | Cornered | 2.0 | 20 | 93.6 | AA | CC |
| Example 12 | 1 | 1 | 1 | TiO₂ | 30 | A | 0.3 | 0.8 | — | — | A1 | 20 | Cornered | 0.5 | 40 | 93.2 | AA | CC |
| Example 13 | 12 | 12 | 1 | TiO₂ | 30 | G | 0.3 | 0.8 | — | — | A1 | 20 | Cornered | 1.0 | 20 | 93.4 | AA | BB |
| Example 14 | 13 | 13 | 1 | TiO₂ | 30 | H | 0.3 | 0.8 | — | — | A1 | 20 | Cornered | 2.5 | 20 | 93.1 | AA | EE |
| Comparative | 14 | 14 | 7 | PY74 | 10 | A | 0.3 | 0.8 | — | — | A1 | 20 | Cornered | 0.5 | 20 | DD | DD | FF |
| Example 1 | | | | | | | | | | | | | | | | | | |
| Comparative | 15 | 15 | 1 | TiO₂ | 30 | I | 0.3 | 0.8 | 0.5 | — | — | — | — | — | 20 | 93.5 | AA | EE |
| Example 2 | | | | | | | | | | | | | | | | | | |
| Comparative | 16 | 16 | 1 | TiO₂ | 30 | J | 0.3 | 0.8 | — | — | A5 | 70 | Cornered | 0.5 | 20 | 93.2 | AA | EE |
| Example 3 | | | | | | | | | | | | | | | | | | |
| Comparative | 17 | 17 | 1 | TiO₂ | 30 | K | 0.3 | 0.8 | — | 1.0 | — | — | — | — | 20 | 93.1 | AA | EE |
| Example 4 | | | | | | | | | | | | | | | | | | |

From the above results, it can be seen that the toner of the present invention suppresses toner scattering when printing with high-coverage and has higher whiteness than the toners of the Comparative Examples.

Although several embodiments of the present invention have been described, the scope of the present invention is not limited to the above-described embodiments, and includes the scope of the invention described in the claims and equivalents thereof.

Although embodiments of the present invention have been described and illustrated in detail, the disclosed embodiments are made for purposes of illustration and example only and not limitation The scope of the present invention should be interpreted by terms of the appended claims

What is claimed is:

1. A toner for developing an electrostatic image, comprising:
toner base particles containing a binder resin and an inorganic pigment; and
an external additive,
wherein the external additive contains alumina particles, and
a number average particle size of primary particles of the alumina particles is in the range of 5 nm to 60 nm.

2. The toner for developing an electrostatic image according to claim 1,
wherein of the toner contains the inorganic pigment in the range of 10% to 70% by mass of a total amount of the binder resin.

3. The toner for developing an electrostatic image according to claim 1,
wherein of the toner contains the inorganic pigment in the range of 20% to 40% by mass of a total amount of the binder resin.

4. The toner for developing an electrostatic image according to claim 1,
wherein the inorganic pigment contains titanium oxide particles.

5. The toner for developing an electrostatic image according to claim 1,
wherein the alumina particles have a cornered shape.

6. The toner for developing an electrostatic image according to claim 1,
wherein of the toner contains the alumina particles in the range of 0.1% to 2.0% by mass of a total amount of the toner base particles.

7. An image forming method using the toner for developing an electrostatic image according to claim 1, comprising:
printing an image at a coverage of 20% or more.
